(19) United States
(12) Patent Application Publication
(10) Pub. No.: US 2024/0378743 A1
(43) Pub. Date: Nov. 14, 2024

(54) OBJECT DETECTION USING TOP VIEW AND CYLINDRICAL REPRESENTATIONS OF SURROUNDING AREAS FOR VEHICLE APPLICATIONS

(71) Applicant: QUALCOMM Incorporated, San Diego, CA (US)

(72) Inventors: Varun Ravi Kumar, San Diego, CA (US); Senthil Kumar Yogamani, Headford (IE)

(21) Appl. No.: 18/314,592

(22) Filed: May 9, 2023

(51) Int. Cl. G06T 7/73; G06T 7/10; G06V 20/58

(52) U.S. Cl. CPC G06T 7/73; G06T 7/10; G06V 20/58; G06T 2207/30261; G06T 2210/12

(57) ABSTRACT

This disclosure provides systems, methods, and devices for vehicle driving assistance systems that support image processing. In a first aspect, a method is provided that includes determining a first set of feature vectors for received images for a top view representation of an area surrounding a vehicle and a second set of feature vectors for a cylindrical representation of the area. The method may further include determining a first set of locations based on the first set of feature vectors and determining a second set of locations based on the second set of feature vectors. A third set of locations may be determined based on the first and second sets of locations, such as combining the first and second sets using a transformer attention process. Vehicle control instructions may then be determined based on the third set of locations. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

One aspect includes a method for image processing for use in a vehicle assistance system. The method includes receiving image frames of an area surrounding a vehicle. The method also includes determining a first set of feature vectors for the image frames, where the first set of feature vectors identify features within a top view representation of the area surrounding the vehicle. The method also includes determining a second set of feature vectors for the image frames, where the second set of feature vectors identify features within a cylindrical representation of the area surrounding the vehicle. The method also includes determining, based on the first set of feature vectors, a first set of locations for objects within the area surrounding the vehicle. The method also includes determining, based on the second set of feature vectors, a second set of locations for objects within the area surrounding the vehicle. The method also includes determining, based on the first set of locations and the second set of locations, a third set of locations for objects within the area surrounding the vehicle. The method also includes determining vehicle control instructions based on the third set of locations.

Another aspect includes an apparatus. The apparatus also includes a memory storing processor-readable code and at least one processor coupled to the memory. The at least one processor may be configured to execute the processor-readable code to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations.

An additional aspect includes a non-transitory computer-readable medium storing instructions that, when executed by a processor, cause the processor to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations.

A further aspect includes a vehicle that includes image sensors, a memory storing processor-readable code, and at least one processor coupled to the memory. The at least one processor may be configured to execute the processor-readable code to cause the at least one processor to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating object detection using top view and cylindrical representations of surrounding areas according to one or more aspects of the disclosure.

FIG. 5A depicts a top view of an area surrounding a vehicle according to one aspect of the present disclosure.

FIG. 5B depicts a view of a cylindrical representation of an area around a vehicle according to an exemplary embodiment of the present disclosure.

FIG. 5C depicts a mapping between top view and cylindrical representations according to an exemplary embodiment of the present disclosure.

FIG. 6 is a flow chart illustrating an example method for object detection using top view and cylindrical representations of surrounding areas according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support object detection using top view and cylindrical representations of surrounding areas. In particular, to monitor the area surrounding a vehicle, multiple views of the vehicle's surrounding area may be used. These views may include a perspective view from one or more cameras located on the vehicle. Additionally, top views, also known as birds eye views, provide a top-down view of the vehicle and its surroundings. Specifically, top view segmentation maps that distinguish between different objects in an environment may be utilized in vehicle applications to provide a 360-degree view of the surroundings. This technology utilizes cameras and sensors to create a detailed map of the area around the vehicle and can be used for navigation, parking assistance, collision avoidance, and other safety features. Top view segmentation maps may be determined based on perspective view image frames captured from cameras located on the vehicle (such as by transforming and combining multiple image frames into a top view of an area surrounding the vehicle).

However, top view representations of areas surrounding a vehicle may not be adequate for accurately representing or detecting all types of objects within an environment that surrounds the vehicle. For example, thinner or narrower objects such as pedestrians, vertical street lights, and signs may be more difficult to represent within top view representations. In particular, limited spatial resolution for certain types of top view representations (such as resolutions of 0.5 meters per pixel, 0.8 meters per pixel, 1 meter per pixel, 1.5 meters per pixel, and the like) may cause many such objects to only be represented with a single pixel within the top view representation. Accordingly, downstream processing tasks may suffer from accuracy issues.

One solution to this problem is to fuse or otherwise combine multiple representations of an area surrounding a vehicle when performing object detection within the area. For example, a first set of feature vectors may be determined for received images of the surrounding area. The first set of feature vectors may represent features within the images based on a top view representation of the surrounding area. A second set of feature vectors may be determined for the image frames and may represent features within a cylindrical representation of the surrounding area. In certain instances, the second set of feature vectors may be determined based on the first set of feature vectors. Locations for objects within the surrounding environment may then be determined based on the first and second sets of feature vectors. For example, a first set of locations may be determined based on the first set of feature vectors, and a second set of locations may be determined based on the second set of feature vectors. A third set of locations may be determined for the objects based on the first and second sets of locations. For example, the third set of locations may be determined by combining the first set of locations and the second set of locations according to a transformer attention process. Vehicle control instructions may then be determined based on the third set of locations.

Stated differently, the proposed techniques address the limitations of birds eye view (BEV) presentations for object detection, such as for autonomous driving. By using camera encoders and multiview spatial transformers, the input space can be transformed into both top views and cylindrical views, which can then be fused to improve object detection accuracy. This technique complements the weaknesses of top views and allows for better detection of thin objects such as traffic signs and pedestrians.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the locations for objects determined by combining the first and second sets of locations may leverage the benefits of each representation of the surrounding environment to resolve shortcomings in the other representation. In particular, the top view representation may provide improved width and depth information for detecting objects, and the cylindrical representation may provide improved detection of smaller objects and improved height information for detecting objects. In this way, the proposed techniques improve the overall tracking quality of objects within an area surrounding vehicles. One major benefit of improved object tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By expanding the number, type, and variety of surrounding vehicles that can be detected, these systems can offer more accurate alerts and assistance to drivers when necessary, without generating unnecessary notifications or distractions.

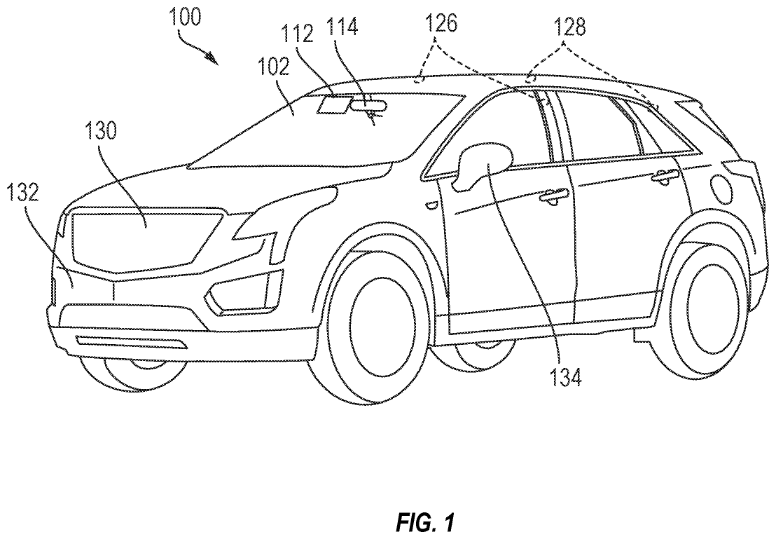

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

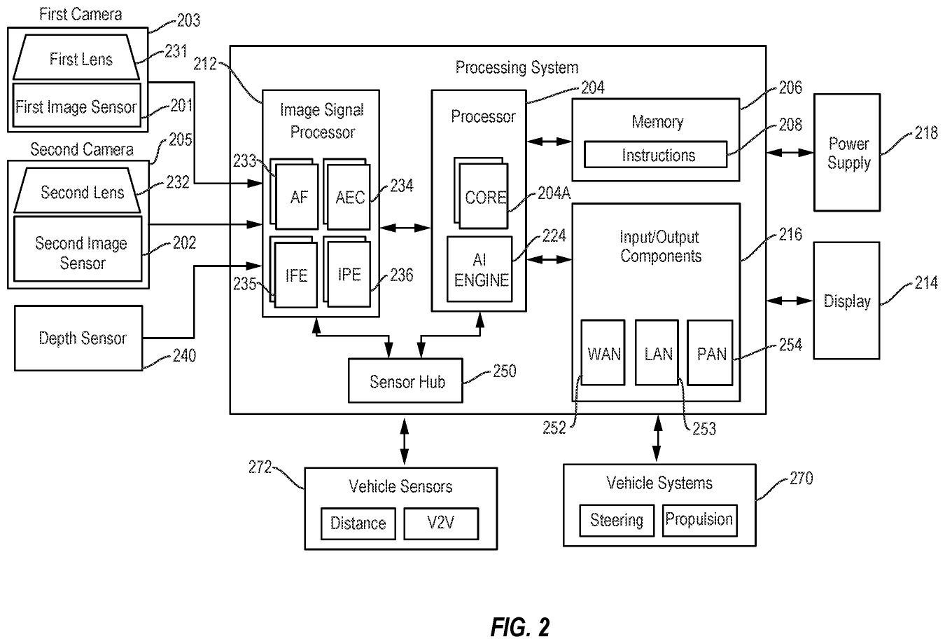

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

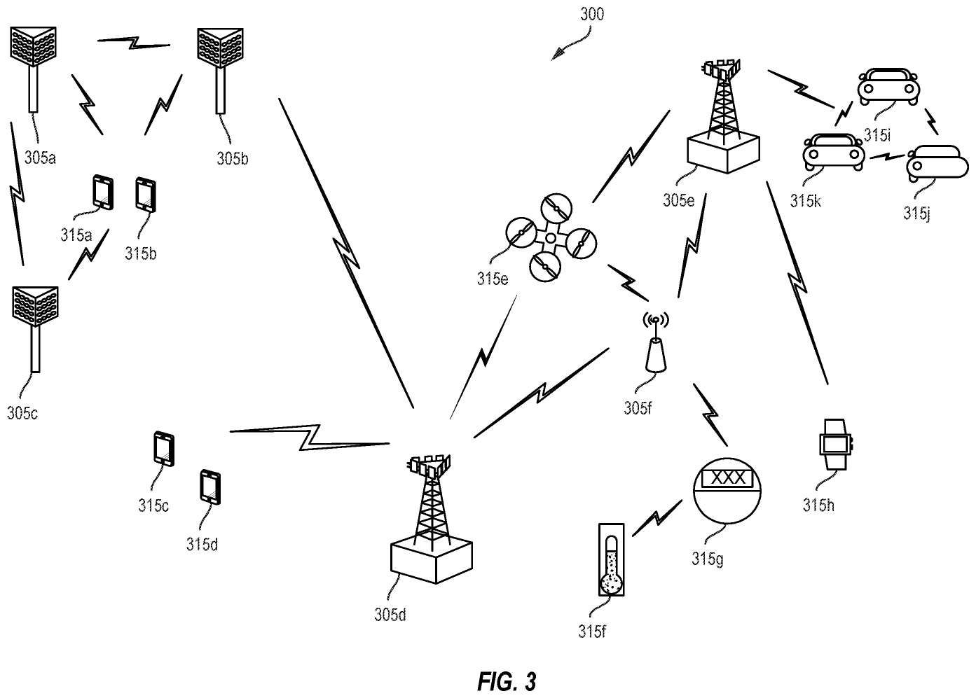

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

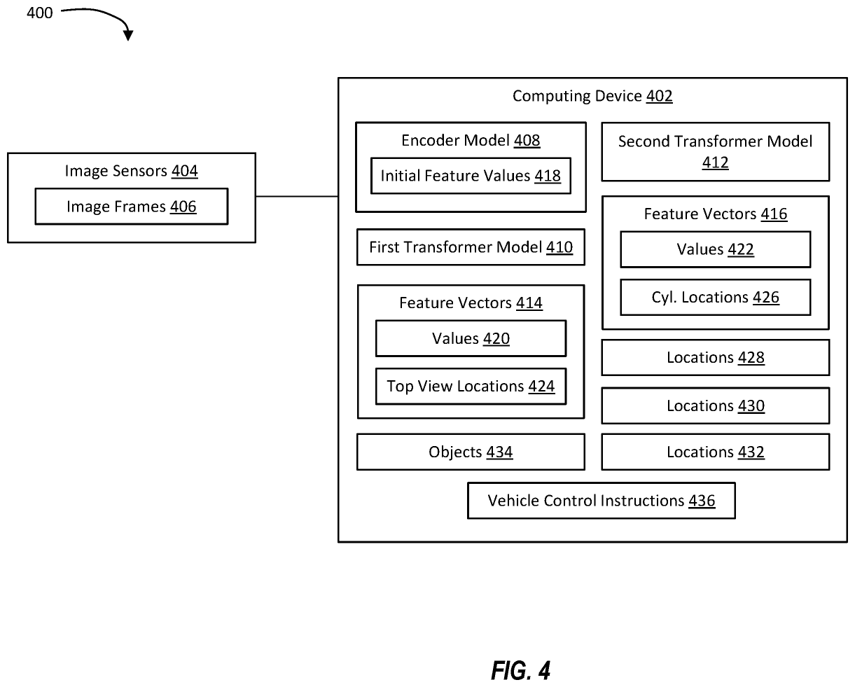

Aspects of the vehicular systems described with reference to, and shown in, FIG. 1, FIG. 2, and FIG. 3 may include object detection using top view and cylindrical representations of surrounding areas. For example, FIG. 4 is a block diagram of a system 400 for object detection using top view and cylindrical representations of surrounding areas according to an exemplary embodiment of the present disclosure. The system 400 includes a computing device 402 and image sensors 404, which include images 406. The computing device 402 includes an encoder model 408, a first transformer model 410, a first set of feature vectors 414, a second transformer model 412, a second set of feature vectors 416, a first set of locations 428, a second set of locations 430, a third set of locations 432, objects 434, and vehicle control instructions 436. The encoder model 408 includes initial feature vectors 418. The first set of feature vectors 414 includes values 420 and top view locations 424. The second set of feature vectors 416 includes values 422 and cylindrical locations 426.

The computing device 402 may be configured to receive image frames 406 of an area surrounding a vehicle. In certain implementations, the image frames 406 may be captured from an area around a vehicle. For example, the vehicle may be equipped with one or more image sensors 404. These image sensors 404 may be configured to capture images 406 on a regular basis. the captured images 406 may cover a wide range of angles and distances, providing a comprehensive view of the area around the vehicle. In certain implementations, the image frames 406 may include a single image that has been captured by a single image sensor 404. In other implementations, the image frames 406 may include multiple image frames 406 that have been captured by a single image sensor 404, such as a stream of image frames 406 captured by the image sensor 404. In additional or alternative implementations, the image frames 406 may include multiple image frames 406 that have been captured by multiple image sensors 404, such as multiple image sensors 404 facing different portions of an area surrounding the vehicle.

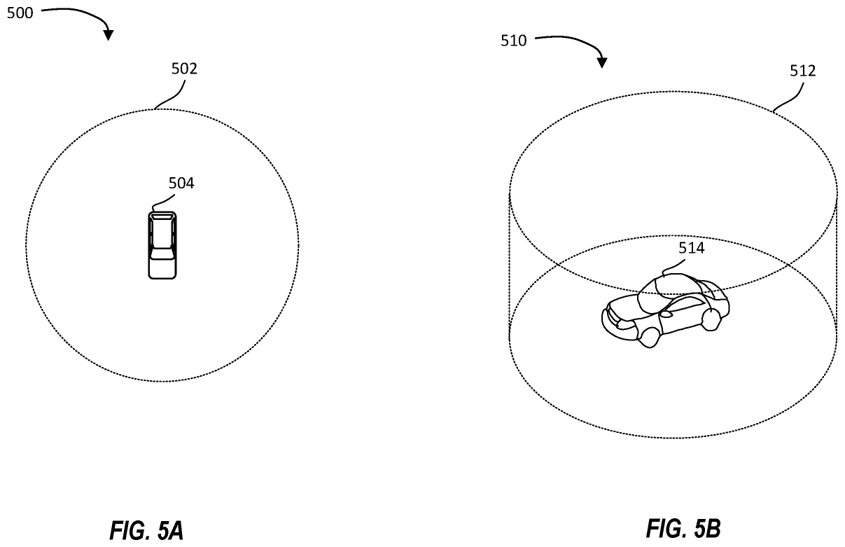

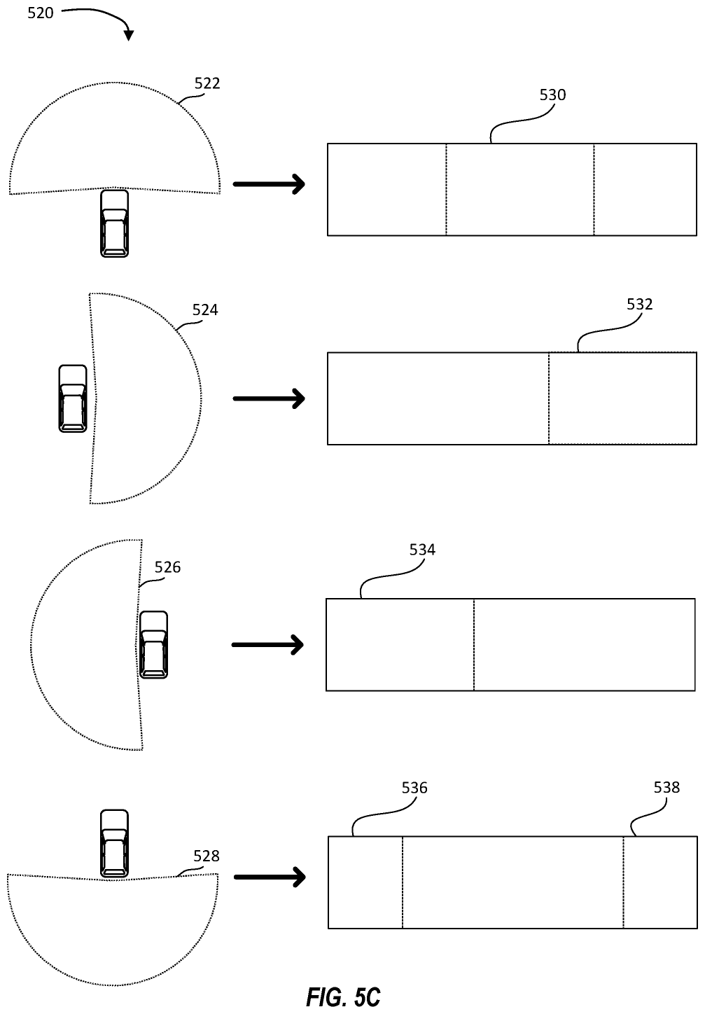

The computing device 402 may be configured to determine a first set of feature vectors 414 for the image frames 406. The first set of feature vectors 414 may identify features within a top view representation of the area surrounding the vehicle. In certain implementations, the top view representation shows the vehicle and its surroundings as if viewed from above. For example, FIG. 5A depicts a top view 500 of an area 502 surrounding a vehicle 504 according to an exemplary embodiment of the present disclosure. As can be seen in FIG. 5A, the top view 500 includes top-down representations of the area 502. Although not depicted in FIG. 5A, top views may similarly include top-down representations of objects located in the area 502.

In certain implementations, the first set of feature vectors 414 specify (i) values 420 and (ii) top view locations 424 for a first plurality of features. In certain implementations, the plurality of features may include numerical representations of various aspects of an image frame. Some examples of features include color histograms, texture descriptors, edge detection, and shape analysis. Color histograms may quantify the distribution of colors in an image frame, while texture descriptors may capture patterns such as roughness or smoothness. Edge detections may identify boundaries between objects 434 in an image, while shape analysis may identify or otherwise distinguish different types of objects 434 based on geometric properties of the object within the image frame. In certain implementations, feature vectors may be single-dimensional, such as an N×1 vector, where N may be the number of features. In additional or alternative implementations, feature vectors may be multi-dimensional, such as an N×M×O vector, where at least two of N, M, and O are greater than 1. In certain implementations, the plurality of features may be selected or otherwise identified during training of a model used to determine the feature vectors, such as an encoder model 408 as explained further below.

In certain implementations, the top view locations 424 may be determined by projecting feature locations within the images 406 to corresponding locations within the area surrounding the vehicle. For example, the top view locations 424 may be determined based on the position, size, and orientation of certain features, as well as based on known orientations of the image sensors 404 relative to the vehicle (such as which portions of the physical area are covered by image sensors 404 that captured the images 406. In certain implementations, the top view locations 424 may be determined by one or more machine learning models, such as the first transformer model 410 discussed further below. In certain implementations, the top view locations 424 specify coordinates of features within the feature vectors relative to a location of the vehicle. For example, the coordinates may specify a distance from the vehicle and an angular offset from a heading of the vehicle for corresponding features. In certain implementations, the top view locations 424 may be determined as polar coordinates within the area surrounding the vehicle. In certain implementations, top view locations 424 may be determined for each feature of the feature vectors 414. In additional or alternative implementations, top view locations 424 may only be determined for a subset of the features within the feature vectors 414. In certain implementations, a range or size of the top view for the vehicle may be predetermined (such as a range within 200 meters surrounding the vehicle, 150 meters surrounding the vehicle, 100 meters surrounding the vehicle, 50 meters surrounding the vehicle, and the like). In certain implementations, a resolution of the top view may differ from a resolution of one or more of the received images 406. For example, in certain implementations, the top view may have a resolution of 128×128 pixels, 256×256 pixels, 512×512 pixels, and the like.

In certain implementations, the first set of feature vectors 414 are determined by a first transformer model 410. In certain implementations, the first transformer model 410 may be implemented as a neural network model with a self-attention mechanism. The self-attention mechanism may enable transformer models to process multiple image features simultaneously (such as to identify image features simultaneously). The self-attention mechanism may allow for parallel processing and faster training of the first transformer model 410. In certain implementations, the first set of feature vectors 414 may also be determined using an encoder model 408. Encoder models for image processing may be machine learning models trained to take an input image and encode the input into a lower-dimensional representation, which can be used for various downstream tasks such as image classification, object detection, or image generation. In certain implementations, encoder models may be implemented as neural networks (such as convolutional neural networks, recurrent neural networks), transformer models, autoencoder models, and the like. For example, an encoder model 408 may be trained to identify initial feature values 418 For the features of the first set of feature vectors 414, along with pixel locations for the features. In such implementations, the first transformer model 410 may receive the initial feature values from encoder model 408 and may determine the first set of feature vectors 414 based on the initial feature values 418.

The computing device 402 may be configured to determine a second set of feature vectors 416 for the image frames 406, the second set of feature vectors 416 identify features within a cylindrical representation of the area surrounding the vehicle. In certain implementations, the cylindrical representation may be centered around the vehicle. For example, FIG. 5B depicts a view 510 of a cylindrical representation 512 of an area around a vehicle 514. As can be seen in FIG. 5B, the cylindrical representation may be represented as a cylindrical-shaped surface that is centered on the vehicle 514. Features may be projected on to the surface. In certain implementations, a height of the cylindrical representation 512 may be determined based on a vertical field of view for one or more image sensors 404 that captured the image frames 406. For example, the cylindrical representation 512 may have a width (or diameter) and a height. In certain implementations, the diameter of the cylindrical representation 512 may be predetermined. For example, the diameter of the cylindrical representation 512 may be the same as the diameter of the top view representation 500. In further implementations, the diameter may differ from that of the top view representation 500 but may be known (such as 50 m, 100 m, 200 m, and the like). The height of the cylindrical representation 512 may be determined based on a vertical field of view of the cameras that captured the images 406 and the diameter of the cylindrical representation. In particular, the height may be determined by projecting the vertical field of view to the surface of the cylindrical representation 512 such that the height of the cylindrical representation covers the entire vertical field of view of at least one of the image sensors.

In certain implementations, the second set of feature vectors 416 specify (i) values 422 and (ii) cylindrical locations 426 for a second plurality of features. In certain implementations, feature values 422 for the second set of feature vectors 416 may be determined similarly to feature values 420 for the first set of feature vectors 414, as described above. In certain implementations, cylindrical locations 426 may include positions within the cylindrical representation. For example, the cylindrical representation may be mapped to a two-dimensional coordinate space (such as by unrolling or flattening the surface forming the cylindrical representation). In such instances, the cylindrical locations 426 may be specified as two-dimensional coordinates within the coordinate space of the cylindrical representation. In certain implementations, the second set of feature vectors 416 are determined by a second transformer model 412. In certain implementations, similar to the first transformer model 410 described above, the second transformer model 412 may be implemented as a neural network model with a self-attention mechanism.

In certain implementations, the second transformer model 412 determines the second set of feature vectors 416 based on the first set of feature vectors 414. In certain implementations, the second transformer model 412 may transform features from the first set of feature vectors 414 in the top view into the second set of feature vectors 416 in the cylindrical view using cross view transformation techniques. For example, camera intrinsics or extrinsics (such as positions on the vehicle, fields of view, and the like) may be used to transform locations within the top view into locations within the cylindrical view. For example, the second transformer model 412 may include a convolutional neural network trained to project features from top views into features for corresponding cylindrical views.

In certain implementations, the second transformer model 412 determines the second set of feature vectors 416 based on the image frames 406. For example, the second transformer model 412 may be configured to determine the second set of feature vectors 416 based on initial feature values 418 for the image frames 406, such as initial feature values 418 determined by an encoder model 408, as discussed above. In one such implementation, the second transformer model 412 may be configured to receive the initial feature values 418 from encoder model 408 and may determine the first set of feature vectors 414 based on the initial feature values 418.

In certain implementations, each respective image of at least a subset of the images 406 has a corresponding first respective feature vector from the first set of feature vectors 414 and a corresponding second respective feature vector from the second set of feature vectors 416. In certain implementations, the received images 406 may be separately processed to determine corresponding feature vectors. For example, an encoder model 408 (or separate versions of the encoder model 408) may determine initial feature vectors 418 for each of the received images 406. The first transformer model 410 (or separate versions of the first transformer model 410) may then separately receive and process initial feature vectors 418 corresponding to each of the received images 406 in order to determine a corresponding first feature vector within the first set of feature vectors 414. Each of the corresponding first feature vectors may be provided separately to the second transformer model 412 to determine corresponding second feature vectors for each of the received images 406 within the second set of feature vectors 416.

In certain implementations, each respective image of at least a subset of the corresponds to a first respective subset of the top view representation of the area surrounding the vehicle and a second respective subset of the cylindrical representation of the area surrounding the vehicle. For example, FIG. 5C shows a mapping 520 between top view and cylindrical representations according to an exemplary embodiment of the present disclosure. The mapping 520 includes top view sectors 522, 524, 526, 528, which may represent portions of areas surrounding a vehicle that are covered by a particular image sensor (and thus by images received from that image sensor). For example, sector 522 may correspond to a front-facing camera, sector 528 may correspond to a rear-facing camera, and sectors 524, 526 may correspond to side-facing cameras. The mapping 520 identifies corresponding cylindrical sectors 530, 532, 534, 536, 538 of a cylindrical representation for each of the sectors 522, 524, 526, 528. For example, the cylindrical representation in FIG. 5C is represented by a flat rectangular surface, which may represent locations within a corresponding rectangular surface. In the mapping 520, the top view sector 522 corresponds to the cylindrical sector 530, the top view sector 524 corresponds to the cylindrical sector 532, the top view sector 526 corresponds to the cylindrical sector 534, and the top view sector 522 corresponds to the cylindrical sectors 536, 538.

In certain implementations, the first set of feature vectors 414 may have the same features (such as may include feature values for the same types of features) as the second set of feature vectors 416. In additional or alternative implementations, the first set of feature vectors 414 may have different features from the second set of feature vectors 416.

The computing device 402 may be configured to determine, based on the first set of feature vectors 414, a first set of locations 428 for objects 434 within the area surrounding the vehicle. The computing device 402 may also be configured to determine, based on the second set of feature vectors 416, a second set of locations 430 for objects 434 within the area surrounding the vehicle. In certain implementations, the objects 434 may include any object located in an area surrounding the vehicle, such as road signs, vehicles, buildings, and the like. In certain implementations, the objects 434 may be mobile. For example, the objects 434 may include one or more of other vehicles, pedestrians, bicycles, scooters, and the like. In certain implementations, determining the first set of locations 428 includes determining a first fused feature vector based on the first set of feature vectors 414 and determining the first set of locations 428 based on the first fused feature vector. In certain implementations, determining the second set of locations 430 includes determining a second fused feature vector based on the second set of feature vectors 416 and determining the second set of locations 430 based on the second fused feature vector. In certain implementations, determining the fused feature vectors may include combining features from within each set of feature vectors to determine the fused vectors. As described above, feature values 420, 422 contained within the first set of feature vectors 414 and the second set of feature vectors 416 may contain corresponding locations 424, 426 within the top view representation or the cylindrical representation of the area surrounding the vehicle.

In certain implementations, determining the fused feature vectors may include combining features and corresponding feature values 420, 422 from multiple locations within a particular representation in order to provide complete coverage (such as 360° coverage) of the area surrounding the vehicle within that particular representation. As a particular example, the first set of feature vectors 414 may be combined to form the first fused feature vector to provide a complete top view representation of the area surrounding the vehicle. As another example, the second set of feature vectors 416 may be combined to form the second fused feature vector to provide a complete cylindrical representation of the area surrounding the vehicle. In certain implementations, a particular feature within one of the feature vectors may not have a corresponding feature at the same location within another feature vector. For example, as noted above in connection with FIG. 5C, certain portions of the area surrounding the vehicle may only be covered by a single camera. In such instances, particular features may only be represented in a single feature vector and the corresponding feature within the fused feature vector may be determined as the value from the single feature vector. In additional or alternative instances, more than one feature vector may have corresponding feature values 420, 422 for a particular location within the area surrounding this vehicle. In such instances, these feature values 420, 422 may be combined as a weighted combination of their respective values 420, 422 (such as evenly weighted between vectors, unevenly weighted between vectors, spatially varying weights for different portions of a camera's field of view, and the like) to form the feature value within the fused feature vector.

In certain implementations, one or both of the first set of locations 428 in the second set of locations 430 may include an identifier of the corresponding feature vectors used to determine the locations, the corresponding view used to determine their locations, or combinations thereof. For example, the first set of locations 428 may include an indication that the locations were determined from a top view representation of the area surrounding the vehicle. As another example, the second set of locations 430 may include an indication that the locations were determined from a cylindrical representation of the area surrounding the vehicle. In certain implementations, these indications may be included as metadata for the locations (such as metadata for bounding boxes contained within the sets of locations). In additional or alternative implementations, locations determined based on different representations of the areas surrounding the vehicle may be grouped separately, such that the source group in which a location may be stored serves as the indication of the corresponding view. In certain implementations, the first set of locations 428 and the second set of locations 430 are determined as bounding boxes for objects 434 within the area surrounding the vehicle. In certain implementations, the bounding boxes may be determined as three-dimensional bounding boxes for the objects 434. In additional or alternative implementations, the bounding boxes may be determined as two-dimensional bounding boxes for the objects 434. In certain implementations, one or both of the first set of locations 428 and the second set of locations 430 may be determined using a machine learning model. For example, the first set of locations 428 may be determined using a first machine learning model trained to detect objects 434 and determine object locations within top view representations of areas surrounding vehicles. As another example, the second set of locations 430 may be determined using a second machine learning model trained to detect objects 434 and determine object locations within cylindrical representations of areas surrounding vehicles. In certain implementations, one or both of the first machine learning model and the second machine learning model may be implemented as decoder models. decoder models for image processing may be machine learning models trained to take an input of one or more features and to generate one or more images 406 based on the received input. In certain implementations, decoder models may be implemented as neural networks (such as convolutional neural networks, recurrent neural networks), transformer models, autoencoder models, and the like. In certain implementations, the machine learning models used to determine the first set of locations 428 and/or the second set of locations 430 may be configured to receive fused feature vectors, such as one or both of the first fused feature vector and the second fused feature vector. In additional or alternative implementations, the machine learning models may be configured to receive separate feature vectors for different portions of the areas surrounding the vehicle. For example, the machine learning models may receive the first set of feature vectors 414 or the second set of feature vectors 416.

The computing device 402 may be configured to determine, based on the first set of locations 428 and the second set of locations 430, a third set of locations 432 for objects 434 within the area surrounding the vehicle. As noted above, top view representations of objects 434 surrounding a vehicle and cylindrical representations of objects 434 surrounding a vehicle may have different strengths and weaknesses. For example, top view representations (and corresponding bounding boxes) may have more accurate width and depth information for objects 434 identified in the environment. As another example, cylindrical representations may have more accurate height information for objects 434 detected within the environment. Furthermore, cylindrical representations may have better width information for narrow objects or objects that do not occupy significant space within top views (such as objects with widths or depths less than 1 meter). Accordingly, the third set of locations 432 may be determined to combine the strengths of both types of representations. For example, the third set of locations 432 may combine the improved width and depth information for objects 434 from the first set of locations 428 with the improved height information from the second set of locations 430 and improved width information for narrow objects 434 from the second set of locations 430. In certain implementations, the third set of locations 432 are determined based on a transformer attention process that receives the first set of weighted feature vectors and the second set of weighted feature vectors. In certain implementations, the first set of locations 428 are provided as queries to the transformer attention process and the second set of locations 430 are provided as keys to the transformer attention process. In certain implementations, the third set of bounding boxes are determined based on output values from the transformer attention process. In certain implementations, the computing device 402 may be configured to utilize the transformer attention process to fuse feature values from the first set of locations 428 and the second set of locations 430 (such as bounding box locations and dimensions). The transformer attention process may operate in practice as a mapping between a query vector and a key vector to an output vector, where values 420 422 within the output vector are determined as a weighted combination of corresponding values from the query vector and the key vector. In certain implementations, the weights assigned to each value may be determined by a compatibility function between the query vector and the key vector. The compatibility function may be determined during training for the transformer attention process, and may enable feature vectors from multiple features to be combined into a single weighted value within the output vector. In certain implementations, the first set of locations 428 may be provided as the query vector(s) and the second set of locations 430 are provided as the key vector(s). In such implementations, in response to the received query and key vectors, the attention process may generate one or more values. These values may serve as the fused values for the third set of locations 432. For example, the fused values may include one or more weighted combinations of dimensions and locations for bounding boxes around objects 434 detected within the surrounding environment. In certain implementations, the fused values may also include selecting between objects 434 that are detected in one view but are not detected in another view (and thus may be included in one set of locations and not included in another set of locations).

The computing device 402 may be configured to determine vehicle control instructions 436 based on the third set of locations 432. For example, the computing device 402 may determine the vehicle control instructions 436 to navigate around one or more objects 434 within the third set of locations 432 (such as pedestrians, other vehicles, obstacles). As another example, the computing device 402 may determine the instructions based on certain objects 434 within the third set of locations 432 (such as to comply with information from detected signs or traffic signals). In certain implementations, vehicle control instructions 436 may refer to the set of commands and guidelines that directly or indirectly regulate the movement of a vehicle. These instructions may come in the form of direct vehicular control instructions, such as steering, braking, accelerating or combinations thereof. In additional or alternative implementations, vehicle control instructions 436 may be supplementary instructions that support driver assistance programs, such as obstacle avoidance, blind spot monitoring, and other driver assistance alerts. Control instructions may accordingly help drivers to maintain safe operation of vehicles while driving on roads and highways.

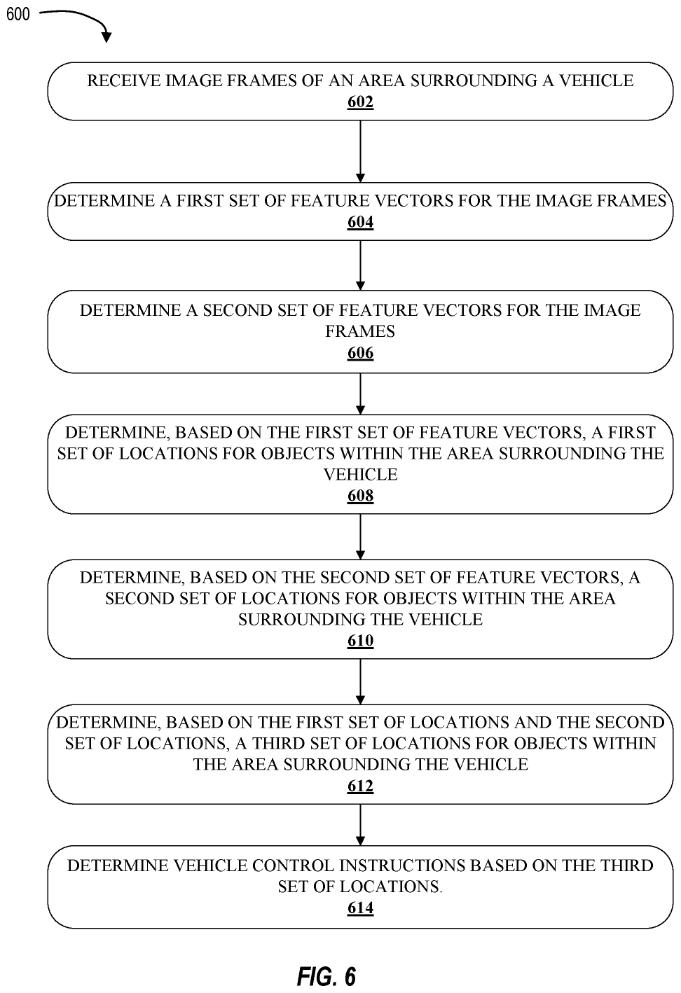

One method of performing image processing according to embodiments described above is shown in FIG. 6. FIG. 6 is a flow chart illustrating an example method 600 for object detection using top view and cylindrical representations of surrounding areas. The method may be performed by one or more of the above systems, such as the systems 100, 200, 300, 400.

The method 600 includes receive image frames of an area surrounding a vehicle (block 602). For example, the computing device 402 may receive image frames 406 of an area surrounding a vehicle. In certain implementations, the image frames 406 may be captured from an area around a vehicle.

The method 600 includes determining a first set of feature vectors for the image frames (block 604). For example, the computing device 402 may determine a first set of feature vectors 414 for the image frames 406. The first set of feature vectors 414 may identify features within a top view representation of the area surrounding the vehicle. In certain implementations, the top view representation shows the vehicle and its surroundings as if viewed from above. In certain implementations, the first set of feature vectors 414 specify (i) values 420 and (ii) top view locations 424 for a first plurality of features. In certain implementations, the first set of feature vectors 414 may also be determined using an encoder model 408.

The method 600 includes determining a second set of feature vectors for the image frames (block 606). For example, the computing device 402 may determine a second set of feature vectors 416 for the image frames 406. The second set of feature vectors 416 may identify features within a cylindrical representation of the area surrounding the vehicle. In certain implementations, the cylindrical representation may be centered around the vehicle. In certain implementations, a height of the cylindrical representation may be determined based on a vertical field of view for one or more image sensors 404 that captured the image frames 406. In certain implementations, the second set of feature vectors 416 specify (i) values 422 and (ii) cylindrical locations 426 for a second plurality of features. In certain implementations, cylindrical locations 426 may include positions within the cylindrical representation. In certain implementations, the second set of feature vectors 416 are determined by a second transformer model 412. In certain implementations, the second transformer model 412 determines the second set of feature vectors 416 based on the first set of feature vectors 414. In certain implementations, the second transformer model 412 determines the second set of feature vectors 416 based on the image frames 406. In certain implementations, each respective image of at least a subset of the images 406 has a corresponding first respective feature vector from the first set of feature vectors 414 and a corresponding second respective feature vector from the second set of feature vectors 416. In certain implementations, the received images 406 may be separately processed to determine corresponding feature vectors. In certain implementations, each respective image of at least a subset of the corresponds to a first respective subset of the top view representation of the area surrounding the vehicle and a second respective subset of the cylindrical representation of the area surrounding the vehicle.

The method 600 includes determining, based on the first set of feature vectors, a first set of locations for objects within the area surrounding the vehicle (block 608). For example, the computing device 402 may determine, based on the first set of feature vectors 414, a first set of locations 428 for objects 434 within the area surrounding the vehicle. The method 600 also includes determining, based on the second set of feature vectors, a second set of locations for objects within the area surrounding the vehicle (block 610). For example, the computing device 402 may determine, based on the second set of feature vectors 416, a second set of locations 430 for objects 434 within the area surrounding the vehicle. In certain implementations, the objects 434 may include any object located in an area surrounding the vehicle. In certain implementations, determining the first set of locations 428 includes determining a first fused feature vector based on the first set of feature vectors 414 and determining the first set of locations 428 based on the first fused feature vectors. In certain implementations, determining the second set of locations 430 includes determining a second fused feature vector based on the second set of feature vectors 416 and determining the second set of locations 430 based on the second fused feature vectors. In certain implementations, determining the fused feature vectors may include combining features from within each set of feature vectors to determine the fused vectors. In certain implementations, one or both of the first set of locations 428 and the second set of locations 430 may include an identifier of the corresponding feature vectors used to determine the locations, the corresponding view used to determine their locations, or combinations thereof. In certain implementations, the first set of locations 428 and the second set of locations 430 are determined as bounding boxes for objects 434 within the area surrounding the vehicle. In certain implementations, the bounding boxes may be determined as three-dimensional bounding boxes for the objects 434. In additional or alternative implementations, the bounding boxes may be determined as two-dimensional bounding boxes for the objects 434. In certain implementations, one or both of the first set of locations 428 and the second set of locations 430 may be determined using a machine learning model.

The method 600 includes determining, based on the first set of locations and the second set of locations, a third set of locations for objects within the area surrounding the vehicle (block 612). For example, the computing device 402 may determine, based on the first set of locations 428 and the second set of locations 430, a third set of locations 432 for objects 434 within the area surrounding the vehicle. In certain implementations, the third set of bounding boxes are determined based on a transformer attention process that receives the first set of weighted feature vectors and the second set of weighted feature vectors. In certain implementations, the first set of locations 428 are provided as queries to the transformer attention process and the second set of locations 430 are provided as keys to the transformer attention process. In certain implementations, the third set of bounding boxes are determined based on output values 420 422 from the transformer attention process.

The method 600 includes determining vehicle control instructions based on the third set of locations (block 614). For example, the computing device 402 may determine vehicle control instructions 436 based on the third set of locations 432. For example, the computing device 402 may determine the vehicle control instructions 436 to navigate around one or more objects 434 within the third set of locations 432 (such as pedestrians, other vehicles, obstacles).

It is noted that one or more blocks (or operations) described with reference to FIG. 6 may be combined with one or more blocks (or operations) described with reference to another of the figures. For example, one or more blocks (or operations) of FIG. 6 may be combined with one or more blocks (or operations) of FIG. 1-4. As another example, one or more blocks associated with FIG. 5 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. A first aspect includes a method for image processing for use in a vehicle assistance system. The method includes receiving image frames of an area surrounding a vehicle. The method also includes determining a first set of feature vectors for the image frames, where the first set of feature vectors identify features within a top view representation of the area surrounding the vehicle. The method also includes determining a second set of feature vectors for the image frames, where the second set of feature vectors identify features within a cylindrical representation of the area surrounding the vehicle. The method also includes determining, based on the first set of feature vectors, a first set of locations for objects within the area surrounding the vehicle. The method also includes determining, based on the second set of feature vectors, a second set of locations for objects within the area surrounding the vehicle. The method also includes determining, based on the first set of locations and the second set of locations, a third set of locations for objects within the area surrounding the vehicle. The method also includes determining vehicle control instructions based on the third set of locations.

In a second aspect, in combination with the first aspect, determining the first set of feature vectors includes determining a first fused feature vector based on the first set of feature vectors and determining the first set of locations based on the first fused feature vector.

In a third aspect, in combination with one or more of the first aspect through the second aspect, determining the second set of feature vectors includes determining a second fused feature vector based on the second set of feature vectors and determining the second set of locations based on the second fused feature vector.

In a fourth aspect, in combination with one or more of the first aspect through the third aspect, the first set of locations and the second set of locations are determined as bounding boxes for objects within the area surrounding the vehicle.

In a fifth aspect, in combination with one or more of the first aspect through the fourth aspect, a height of the cylindrical representation is determined based on a vertical field of view for one or more image sensors that captured the image frames.

In a sixth aspect, in combination with one or more of the first aspect through the fifth aspect, the third set of bounding boxes are determined based on a transformer attention process that receives the first set of weighted feature vectors and the second set of weighted feature vectors.

In a seventh aspect, in combination with the sixth aspect, the first set of locations are provided as queries to the transformer attention process and the second set of locations are provided as keys to the transformer attention process.

In an eighth aspect, in combination with the seventh aspect, the third set of locations are determined based on output values from the transformer attention process.

In a ninth aspect, in combination with one or more of the first aspect through the eighth aspect, the first set of feature vectors specify (i) values and (ii) top view locations for a first plurality of features and the second set of feature vectors specify (i) values and (ii) cylindrical locations for a second plurality of features.

In a tenth aspect, in combination with one or more of the first aspect through the ninth aspect, the first set of feature vectors are determined by a first transformer model and the second set of feature vectors are determined by a second transformer model.

In an eleventh aspect, in combination with the tenth aspect, the second transformer model determines the second set of feature vectors based on the first set of feature vectors.

In a twelfth aspect, in combination with one or more of the first through the eleventh aspects, each respective image of at least a subset of the image frames has a corresponding first respective feature vector from the first set of feature vectors and a corresponding second respective feature vector from the second set of feature vectors.

In a thirteenth aspect, in combination with the twelfth aspect, each respective image of at least a subset of the image frames corresponds to a first respective subset of the top view representation of the area surrounding the vehicle and a second respective subset of the cylindrical representation of the area surrounding the vehicle.

A fourteenth aspect includes an apparatus. The apparatus also includes a memory storing processor-readable code and at least one processor coupled to the memory. The at least one processor may be configured to execute the processor-readable code to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a fifteenth aspect, in combination with the fourteenth aspect, determining the first set of feature vectors includes determining a first fused feature vector based on the first set of feature vectors and determining the first set of locations based on the first fused feature vector.

In a sixteenth aspect, in combination with one or more of the fourteenth aspect through the fifteenth aspect, determining the second set of feature vectors includes determining a second fused feature vector based on the second set of feature vectors and determining the second set of locations based on the second fused feature vector.

In a seventeenth aspect, in combination with one or more of the fourteenth aspect through the sixteenth aspect, the first set of locations and the second set of locations are determined as bounding boxes for objects within the area surrounding the vehicle.

In an eighteenth aspect, in combination with one or more of the fourteenth aspect through the seventeenth aspect, a height of the cylindrical representation is determined based on a vertical field of view for one or more image sensors that captured the image frames.

In a nineteenth aspect, in combination with one or more of the fourteenth aspect through the eighteenth aspect, the third set of locations are determined based on a transformer attention process that receives the first set of weighted feature vectors and the second set of weighted feature vectors.

In a twentieth aspect, in combination with the nineteenth aspect, the first set of locations are provided as queries to the transformer attention process and the second set of locations are provided as keys to the transformer attention process.

In a twenty-first aspect, in combination with the twentieth aspect, the third set of bounding boxes are determined based on output values from the transformer attention process.

A twenty-second aspect includes a non-transitory computer-readable medium storing instructions that, when executed by a processor, cause the processor to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations.

In a twenty-third aspect, in combination with the twenty-second aspect, determining the first set of feature vectors includes determining a first fused feature vector based on the first set of feature vectors and determining the first set of locations based on the first fused feature vector.

In a twenty-fourth aspect, in combination with one or more of the twenty-second aspect through the twenty-third aspect, determining the second set of feature vectors includes determining a second fused feature vector based on the second set of feature vectors and determining the second set of locations based on the second fused feature vector.

In a twenty-fifth aspect, in combination with one or more of the twenty-second aspect through the twenty-fourth aspect, the third set of locations are determined based on a transformer attention process that receives the first set of weighted feature vectors and the second set of weighted feature vectors.

In a twenty-sixth aspect, in combination with the twenty-fifth aspect, the first set of locations are provided as queries to the transformer attention process and the second set of locations are provided as keys to the transformer attention process.

A twenty-seventh aspect includes a vehicle that includes image sensors, a memory storing processor-readable code, and at least one processor coupled to the memory. The at least one processor may be configured to execute the processor-readable code to cause the at least one processor to perform operations including receiving image frames of an area surrounding a vehicle. The operations also include determining a first set of feature vectors for the image frames, where the first set of feature vectors identify features within a top view representation of the area surrounding the vehicle. The operations also include determining a second set of feature vectors for the image frames, where the second set of feature vectors identify features within a cylindrical representation of the area surrounding the vehicle. The operations also include determining, based on the first set of feature vectors, a first set of locations for objects within the area surrounding the vehicle. The operations also include determining, based on the second set of feature vectors, a second set of locations for objects within the area surrounding the vehicle. The operations also include determining, based on the first set of locations and the second set of locations, a third set of locations for objects within the area surrounding the vehicle. The operations also include determining vehicle control instructions based on the third set of locations.

In a twenty-eighth aspect, in combination with the twenty-seventh aspect, determining the first set of feature vectors includes determining a first fused feature vector based on the first set of feature vectors and determining the first set of locations based on the first fused feature vector.

In a twenty-ninth aspect, in combination with one or more of the twenty-seventh aspect through the twenty-eighth aspect, determining the second set of feature vectors includes determining a second fused feature vector based on the second set of feature vectors and determining the second set of locations based on the second fused feature vector.

In a thirtieth aspect, in combination with one or more of the twenty-seventh aspect through the twenty-ninth aspect, the third set of locations are determined based on a transformer attention process that receives the first set of weighted feature vectors and the second set of weighted feature vectors.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing for use in a vehicle assistance system, comprising:
receiving image frames of an area surrounding a vehicle;
determining a first set of feature vectors for the image frames, wherein the first set of feature vectors identify features within a top view representation of the area surrounding the vehicle;
determining a second set of feature vectors for the image frames, wherein the second set of feature vectors identify features within a cylindrical representation of the area surrounding the vehicle;
determining, based on the first set of feature vectors, a first set of locations for objects within the area surrounding the vehicle;
determining, based on the second set of feature vectors, a second set of locations for objects within the area surrounding the vehicle;
determining, based on the first set of locations and the second set of locations, a third set of locations for objects within the area surrounding the vehicle; and
determining vehicle control instructions based on the third set of locations.

2. The method of claim 1, wherein determining the first set of feature vectors comprises:
determining a first fused feature vector based on the first set of feature vectors; and
determining the first set of locations based on the first fused feature vector.

3. The method of claim 1, wherein determining the second set of feature vectors comprises:
determining a second fused feature vector based on the second set of feature vectors; and
determining the second set of locations based on the second fused feature vector.

4. The method of claim 1, wherein the first set of locations and the second set of locations are determined as bounding boxes for objects within the area surrounding the vehicle.

5. The method of claim 1, wherein a height of the cylindrical representation is determined based on a vertical field of view for one or more image sensors that captured the image frames.

6. The method of claim 1, wherein the third set of bounding boxes are determined based on a transformer attention process that receives the first set of weighted feature vectors and the second set of weighted feature vectors.

7. The method of claim 6, wherein the first set of locations are provided as queries to the transformer attention process and the second set of locations are provided as keys to the transformer attention process.

8. The method of claim 7, wherein the third set of locations are determined based on output values from the transformer attention process.

9. The method of claim 1, wherein the first set of feature vectors specify (i) values and (ii) top view locations for a first plurality of features and the second set of feature vectors specify (i) values and (ii) cylindrical locations for a second plurality of features.

10. The method of claim 1, wherein the first set of feature vectors are determined by a first transformer model and the second set of feature vectors are determined by a second transformer model.

11. The method of claim 10, wherein the second transformer model determines the second set of feature vectors based on the first set of feature vectors.

12. The method of claim 1, wherein each respective image of at least a subset of the image frames has a corresponding first respective feature vector from the first set of feature vectors and a corresponding second respective feature vector from the second set of feature vectors.

13. The method of claim 12, wherein each respective image of at least a subset of the image frames corresponds to a first respective subset of the top view representation of the area surrounding the vehicle and a second respective subset of the cylindrical representation of the area surrounding the vehicle.

14. An apparatus, comprising:
a memory storing processor-readable code; and
at least one processor coupled to the memory, the at least one processor configured to execute the processor-readable code to cause the at least one processor to perform operations including:
receiving image frames of an area surrounding a vehicle;
determining a first set of feature vectors for the image frames, wherein the first set of feature vectors identify features within a top view representation of the area surrounding the vehicle;
determining a second set of feature vectors for the image frames, wherein the second set of feature vectors identify features within a cylindrical representation of the area surrounding the vehicle;
determining, based on the first set of feature vectors, a first set of locations for objects within the area surrounding the vehicle;
determining, based on the second set of feature vectors, a second set of locations for objects within the area surrounding the vehicle;
determining, based on the first set of locations and the second set of locations, a third set of locations for objects within the area surrounding the vehicle; and
determining vehicle control instructions based on the third set of locations.

15. The apparatus of claim 14, wherein determining the first set of feature vectors comprises:
determining a first fused feature vector based on the first set of feature vectors; and
determining the first set of locations based on the first fused feature vector.

16. The apparatus of claim 14, wherein determining the second set of feature vectors comprises:
determining a second fused feature vector based on the second set of feature vectors; and
determining the second set of locations based on the second fused feature vector.

17. The apparatus of claim 14, wherein the first set of locations and the second set of locations are determined as bounding boxes for objects within the area surrounding the vehicle.

18. The apparatus of claim 14, wherein a height of the cylindrical representation is determined based on a vertical field of view for one or more image sensors that captured the image frames.

19. The apparatus of claim 14, wherein the third set of locations are determined based on a transformer attention process that receives the first set of weighted feature vectors and the second set of weighted feature vectors.

20. The apparatus of claim 19, wherein the first set of locations are provided as queries to the transformer attention process and the second set of locations are provided as keys to the transformer attention process.

21. The apparatus of claim 20, wherein the third set of bounding boxes are determined based on output values from the transformer attention process.

22. A non-transitory computer-readable medium storing instructions that, when executed by a processor, cause the processor to perform operations comprising:
receiving image frames of an area surrounding a vehicle;
determining a first set of feature vectors for the image frames, wherein the first set of feature vectors identify features within a top view representation of the area surrounding the vehicle;
determining a second set of feature vectors for the image frames, wherein the second set of feature vectors identify features within a cylindrical representation of the area surrounding the vehicle;
determining, based on the first set of feature vectors, a first set of locations for objects within the area surrounding the vehicle;
determining, based on the second set of feature vectors, a second set of locations for objects within the area surrounding the vehicle;
determining, based on the first set of locations and the second set of locations, a third set of locations for objects within the area surrounding the vehicle; and
determining vehicle control instructions based on the third set of locations.

23. The non-transitory computer-readable medium of claim 22, wherein determining the first set of feature vectors comprises:
determining a first fused feature vector based on the first set of feature vectors; and
determining the first set of locations based on the first fused feature vector.

24. The non-transitory computer-readable medium of claim 22, wherein determining the second set of feature vectors comprises:
determining a second fused feature vector based on the second set of feature vectors; and
determining the second set of locations based on the second fused feature vector.

25. The non-transitory computer-readable medium of claim 22, wherein the third set of locations are determined based on a transformer attention process that receives the first set of weighted feature vectors and the second set of weighted feature vectors.

26. The non-transitory computer-readable medium of claim 25, wherein the first set of locations are provided as queries to the transformer attention process and the second set of locations are provided as keys to the transformer attention process.

27. A vehicle comprising:
image sensors;
a memory storing processor-readable code; and
at least one processor coupled to the memory, the at least one processor configured to execute the processor-readable code to cause the at least one processor to perform operations including:
receiving, from the image sensors, image frames of an area surrounding a vehicle;
determining a first set of feature vectors for the image frames, wherein the first set of feature vectors identify features within a top view representation of the area surrounding the vehicle;
determining a second set of feature vectors for the image frames, wherein the second set of feature vectors identify features within a cylindrical representation of the area surrounding the vehicle;
determining, based on the first set of feature vectors, a first set of locations for objects within the area surrounding the vehicle;
determining, based on the second set of feature vectors, a second set of locations for objects within the area surrounding the vehicle;
determining, based on the first set of locations and the second set of locations, a third set of locations for objects within the area surrounding the vehicle; and
determining vehicle control instructions based on the third set of locations.

28. The vehicle of claim 27, wherein determining the first set of feature vectors comprises:
determining a first fused feature vector based on the first set of feature vectors; and
determining the first set of locations based on the first fused feature vector.

29. The vehicle of claim 27, wherein determining the second set of feature vectors comprises:
determining a second fused feature vector based on the second set of feature vectors; and
determining the second set of locations based on the second fused feature vector.

30. The vehicle of claim 27, wherein the third set of locations are determined based on a transformer attention process that receives the first set of weighted feature vectors and the second set of weighted feature vectors.
